(19) United States
(12) Patent Application Publication
(10) Pub. No.: US 2014/0367064 A1
(43) Pub. Date: Dec. 18, 2014

(54) METHOD OF SIMULTANEOUSLY MANUFACTURING A PLURALITY OF CRANKSHAFTS

(71) Applicant: GM Global Technology Operations LLC, Detroit, MI (US)

(72) Inventors: Dale Edward Murrish, Troy, MI (US); Keith Hart, Oakland Township, MI (US); Maurice G. Meyer, Defiance, OH (US)

(21) Appl. No.: 13/916,763

(22) Filed: Jun. 13, 2013

(51) Int. Cl. B22D 25/02; F16C 3/08; B22C 9/22

(52) U.S. Cl. CPC B22D 25/02; B22C 9/22; F16C 3/08; F16C 2220/02
USPC 164/137; 164/271

(57) ABSTRACT

A method of simultaneously manufacturing a plurality of crankshafts includes positioning a single core within a cavity of a mold having a first half and a second half together forming an exterior shape of the plurality of crankshafts. The exterior shape of each of the plurality of crankshafts produced thereby includes a plurality of pin bearing journals and a plurality of main bearing journals. The method also includes introducing via a mechanism into the cavity a molten metal to form the plurality of crankshafts. As the molten metal flows into the cavity and around the single core, a hollow section extending through at least one of the plurality of pin bearing journals and at least one of the plurality of main bearing journals of each of the plurality of crankshafts is formed. A system for simultaneously manufacturing a plurality of reduced mass crankshafts using the above method is also disclosed.

### TECHNICAL FIELD

The present disclosure generally relates to a method of simultaneously manufacturing a plurality of crankshafts of the type employed in slider-crank mechanisms.

### BACKGROUND

As an example of a slider-crank mechanism, an engine's crankshaft converts reciprocating linear movement of a piston into rotational movement about a longitudinal axis to provide torque to propel a vehicle, such as but not limited to a train, a boat, a plane, or an automobile. Crankshafts are a vital part of an engine, and are a starting point of engine design. Crankshaft design affects the overall packaging of the engine, and thereby the total mass of the engine. Accordingly, minimizing the size and/or mass of the crankshaft reduces the size and mass of the engine, which has a compounding effect on the overall size, mass and fuel economy of the vehicle.

The crankshaft includes at least one crankpin that is offset from the longitudinal axis, to which a reciprocating piston is attached via a connecting rod. Force applied from the piston to the crankshaft through the offset connection therebetween generates torque in the crankshaft, which rotates the crankshaft about the longitudinal axis. The crankshaft further includes at least one main bearing journal disposed concentrically about the longitudinal axis. The crankshaft is secured to an engine block at the main bearing journals. A bearing is disposed about the main bearing journal, between the crankshaft and the engine block.

In order to reduce weight of the crankshaft, a hollow section may be formed into and extend through each of the crankpins and main bearing journals. The crankshaft is frequently formed or manufactured by a casting process, such as but not limited to a green sand casting process or a shell mold casting process. Any hollow sections formed into the crankpins and/or the main bearing journals are defined by a plurality of different cores that are placed within the mold during the casting process. Each of these different cores must be precisely positioned relative to each other and the mold to properly form the hollow sections in the appropriate locations.

### SUMMARY

A method of simultaneously manufacturing a plurality of crankshafts includes positioning a single core within a cavity of a mold having a first half and a second half together forming an exterior shape of the plurality of crankshafts. The exterior shape of each of the plurality of crankshafts produced thereby includes a plurality of pin bearing journals and a plurality of main bearing journals. The method also includes introducing via a mechanism into the cavity a molten metal to form the plurality of crankshafts. As the molten metal flows into the cavity and around the single core, a hollow section extending through at least one of the plurality of pin bearing journals and at least one of the plurality of main bearing journals of each of the plurality of crankshafts is formed.

The method may also include forming the single core as a unitary piece to have a shape that passes through the at least one of the plurality of pin bearing journals and the at least one of the plurality of main bearing journals of each of the plurality of crankshafts.

The single core may further include a plurality of lengths of material, each forming a planar shape.

The single core may further include a plurality of lengths of material, each forming a non-planar three dimensional shape.

The single core may further include a plurality of lengths of material, each having a cross section defining a non-circular shape.

The non-circular shape of each of the plurality of lengths may be an elliptical shape.

The forming of the single core as a unitary piece to have a shape that passes through the at least one of the plurality of pin bearing journals and the at least one of the plurality of main bearing journals of each of the plurality of crankshafts may include forming the single core to define a plurality of non-linear paths. Each non-linear path may be arranged relative to a longitudinal axis of a respective one of the plurality of crankshafts for at least one of the hollow sections extending through at least one of the plurality of pin bearing journals or at least one of the plurality of main bearing journals of each of the plurality of crankshafts.

According to the method, each non-linear path may include a non-linear path positioned to bend the hollow section away from a high stress region of one of the plurality of crankshafts.

Additionally, each non-linear path may include an angled path that is angled relative to the longitudinal axis of one of the plurality of crankshafts to linearly direct the hollow section away from a high stress region of the respective crankshaft.

The forming of the single core as a unitary piece may include forming the single core to include a plurality of connecting portions. In such a case, each connecting portion may have a surface that defines at least a portion of one of the main bearing journals, one of the pin bearing journals, or one of a plurality of counterweights of one of the plurality of crankshafts.

A system for simultaneously manufacturing a plurality of crankshafts using the above method to reduce crankshaft mass while limiting stress in the subject crankshafts is also disclosed.

The above features and advantages, and other features and advantages of the present disclosure, will be readily apparent from the following detailed description of the embodiment(s) and best mode(s) for carrying out the described invention when taken in connection with the accompanying drawings and appended claims.

### BRIEF DESCRIPTION OF THE DRAWINGS

FIG. 1 is a schematic plan view of a representative plurality of planar cast crankshafts with a single core remaining attached thereto.

FIG. 2 is a schematic cross sectional view taken along cut line 2-2 shown in FIG. 1 showing a cross sectional shape of the single core and the resulting hollow section in one of the plurality of planar cast crankshafts shown in FIG. 1.

FIG. 3 is a schematic plan view of a mold for simultaneously casting the plurality of planar crankshafts with the single core shown in FIG. 3 disposed therein.

FIG. 4 is a schematic diagram of one of the plurality of planar crankshafts shown in FIGS. 1-3.

FIG. 5 is a schematic perspective view of one of a plurality of non-planar cast crankshafts with a portion of a single non-planar core therein shown in phantom.

FIG. 6 is a schematic plan view of a single non-planar core for simultaneously casting the plurality of non-planar crankshafts depicted in FIG. 5.

FIG. 7 is a schematic cross section taken along cut line 7-7 shown in FIG. 6.

FIG. 8 is a flow diagram of a method of simultaneously manufacturing a plurality of crankshafts shown in FIGS. 1-7.

### DETAILED DESCRIPTION

Those having ordinary skill in the art will recognize that terms such as “above”, “below”, “upward”, “downward”, “top”, “bottom”, etc., are used descriptively for the figures, and do not represent limitations on the scope of the invention, as defined by the appended claims.

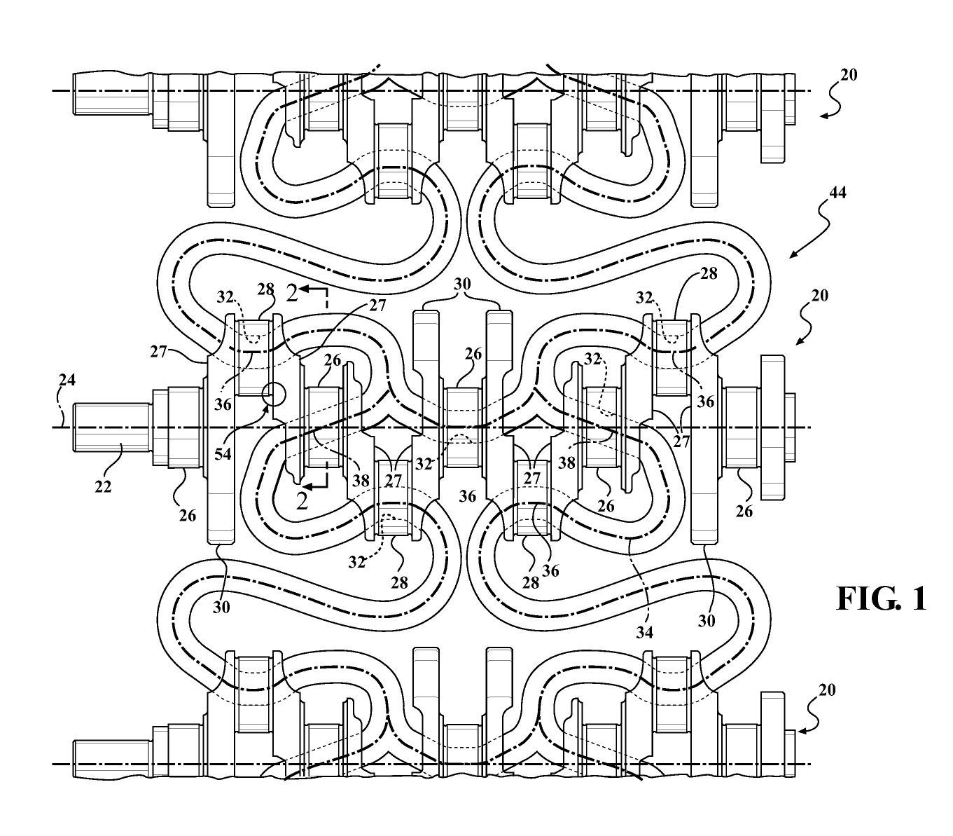

Referring to the Figures, wherein like numerals indicate like parts throughout the several views, a crankshaft is generally shown at 20. Referring to FIG. 1, the crankshaft 20 may be configured for an engine, such as but not limited to an internal combustion gasoline engine or a diesel engine, a compressor, or some other similar device. Typically an engine includes a single crankshaft 20. However, most engine types are manufactured in mass quantities to satisfy demand for certain engines being needed in multiple locations and for various applications. Therefore, a significant quantity of identical or largely similar crankshafts 20 must be produced to satisfy such requirements. The crankshafts 20 are frequently manufactured via a casting process. Accordingly, it may be economically advantageous to cast a number of crankshafts 20 concurrently or simultaneously, rather than casting one such crankshaft at a time. Although the disclosed method is intended to simultaneously manufacture a plurality of crankshafts 20, initially, for illustrative purposes, a single representative crankshaft 20 will be described below.

The crankshaft 20 includes a shaft 22 extending along a longitudinal axis 24 that defines a plurality of main bearing journals 26, a plurality of arms 27, a plurality of pin bearing journals 28, and at least one counterweight 30. The main bearing journals 26 are disposed concentrically about the longitudinal axis 24. Each of the pin bearing journals 28 is laterally offset from the longitudinal axis 24, and is attached to the main bearing journals 26 by an arm. Each of the arms 27 extends from one of the main bearing journals 26 to one of the pin bearing journals 28, and may or may not include one of the counterweights 30. Each of the counterweights 30 extends radially away from the longitudinal axis 24. Each of the main bearing journals 26 support a bearing (not shown) thereabout, and provide an attachment location for attaching the crankshaft 20 to an engine block (not shown). Each of the pin bearing journals 28 support a bearing (not shown) thereabout, and provide the attachment point to which a connecting rod (not shown) attaches a piston (not shown) to the crankshaft 20. The counterweights 30 offset the reciprocating mass of the pistons, piston rings, piston pins and retaining clips, the small ends of the connecting rods, the rotating mass of the connecting rod large ends and bearings, and the rotating mass of the crankshaft itself (the pin bearing journals 28 and the arms 27). The main bearing journals 26 are on the crankshaft axis 24 and do not require any counterweights 30. The counterweights 30 reduce the unbalanced forces acting on the main bearing journals 26 and thereby improve the durability of the bearings. The counterweights 30 balance the rotation of the crankshaft 20 about the longitudinal axis 24 to reduce vibration therein.

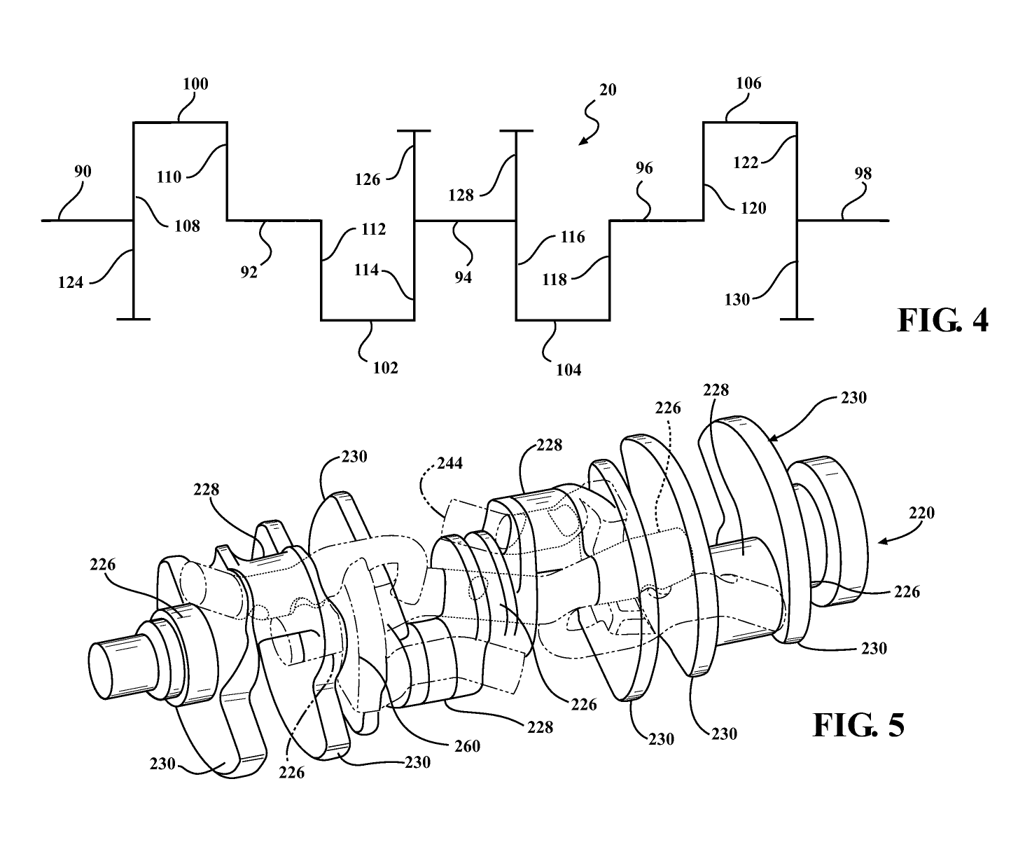

The embodiment of the crankshaft 20 shown in FIG. 1 is for an inline four cylinder engine, and includes four pin bearing journals 28, eight arms 27, five main bearing journals 26, and four counterweights 30. Referring to FIG. 4, the exemplary embodiment of the crankshaft 20 shown in FIG. 1 is shown schematically to include the five main bearing journals 26 numbered 90, 92, 94, 96 and 98 respectively; the four pin bearing journals 28 numbered 100, 102, 104, 106 respectively; the eight arms numbered 108, 110, 112, 114, 116, 118, 120 and 122 respectively; and the four counterweights 30 numbered 124, 126, 128 and 130 respectively. As shown, counterweight 124 is attached to and extends from arm 108, counterweight 126 is attached to and extends from arm 114, counterweight 128 is attached to and extends from arm 116, and counterweight 130 is attached to and extends from arm 122. However, it should be appreciated that the crankshaft 20 may be configured differently than shown in FIGS. 1 and 4. As such, the crankshaft 20 may be configured for any style and/or configuration of engine, including but not limited to a V style engine having six or eight cylinders, or an inline style of engine having 3, 5, 6 or some other number of cylinders. Furthermore, since the arms 27 are structural parts of the crankshaft 20 and the counterweights 30 are merely there to reduce unbalanced forces and vibrations, the crankshaft 20 may have any number of counterweights 30 attached to the various arms 27 in any configuration. For example, an in-line four cylinder crankshaft may include six or eight counterweights. Accordingly, the specific crankshaft 20 shown in FIGS. 1 and 4, and described herein is merely exemplary, and should not be considered as limiting the scope of the claims.

At least one of the pin bearing journals 28 and at least one of the main bearing journals 26 include a hollow section 32 extending therethrough. Each of the hollow sections 32 in the pin bearing journals 28 and the main bearing journals 26 extends generally along the longitudinal axis 24, as described in greater detail below, but not necessarily parallel to the longitudinal axis 24. The hollow sections 32 in the crankshaft 20 reduce the volume of metal used to form the crankshaft 20, thereby reducing the overall weight of the crankshaft 20. Furthermore, by reducing the weight of the pin bearing journals 28, which are laterally offset from the longitudinal axis 24, the mass of the counterweights 30 may also be reduced a corresponding amount, thereby further reducing the overall weight of the crankshaft 20.

Each of the hollow sections 32 extends along a path 34 relative to the longitudinal axis 24 of the shaft 22. The path 34 of each of the hollow sections 32 is configured to minimize stresses within the shaft 22, between the various components thereof, i.e., between the adjoining main bearing journals 26, the pin bearing journals 28 and the arms 27. The path 34 of the hollow sections 32 may include a non-linear path, such as shown at 36 designed to bend the hollow sections 32 away from a high stress region of the crankshaft 20, such as shown at 54, or may include a linear path such as shown at 38 angled relative to the longitudinal axis 24 to angle the hollow section 32 away from the high stress regions 54 of the crankshaft 20. The specific path 34 of each of the hollow sections 32 in the pin bearing journals 28, and the main bearing journals 26, and the cross sectional shape of each of the hollow sections 32 is dependent upon the specific shape, size, and configuration of the crankshaft 20.

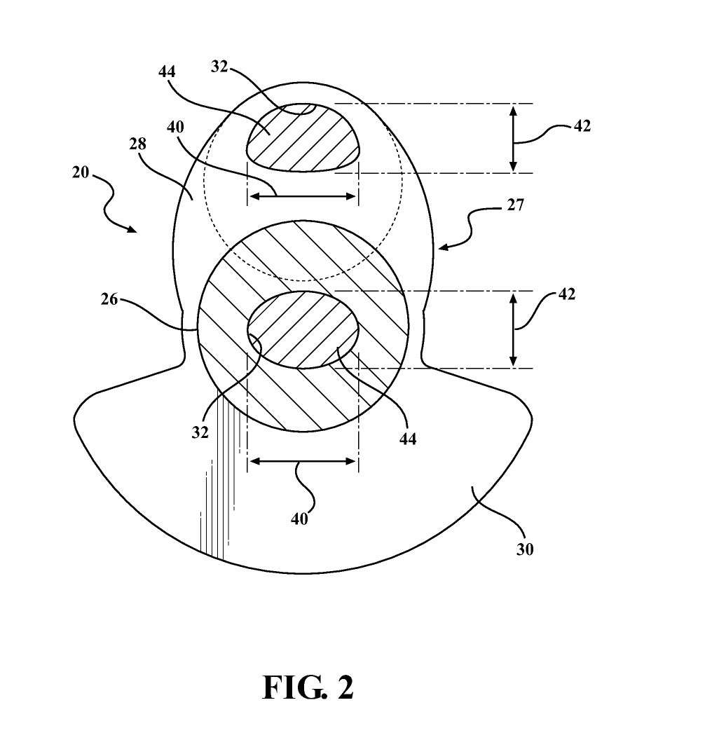

Referring to FIG. 2, each of the hollow sections 32 includes a cross section defining a shape. The cross sectional shape of each of the hollow sections 32 may include but is not limited to a non-circular shape. As shown in FIG. 2, the cross sectional shape of the hollow sections 32 includes an elliptical shape. The elliptical cross sectional shape of each of the hollow sections 32 includes a major axis 40 and a minor axis 42. The major axis 40 preferably includes but is not limited to a distance between the range of 25 mm and 40 mm. The minor axis 42 preferably includes but is not limited to a distance between the range of 15 mm and 35 mm. The elliptical shape of the hollow sections 32 maximizes the reduction in material used to form the crankshaft 20, thereby maximizing the reduction in weight thereof.

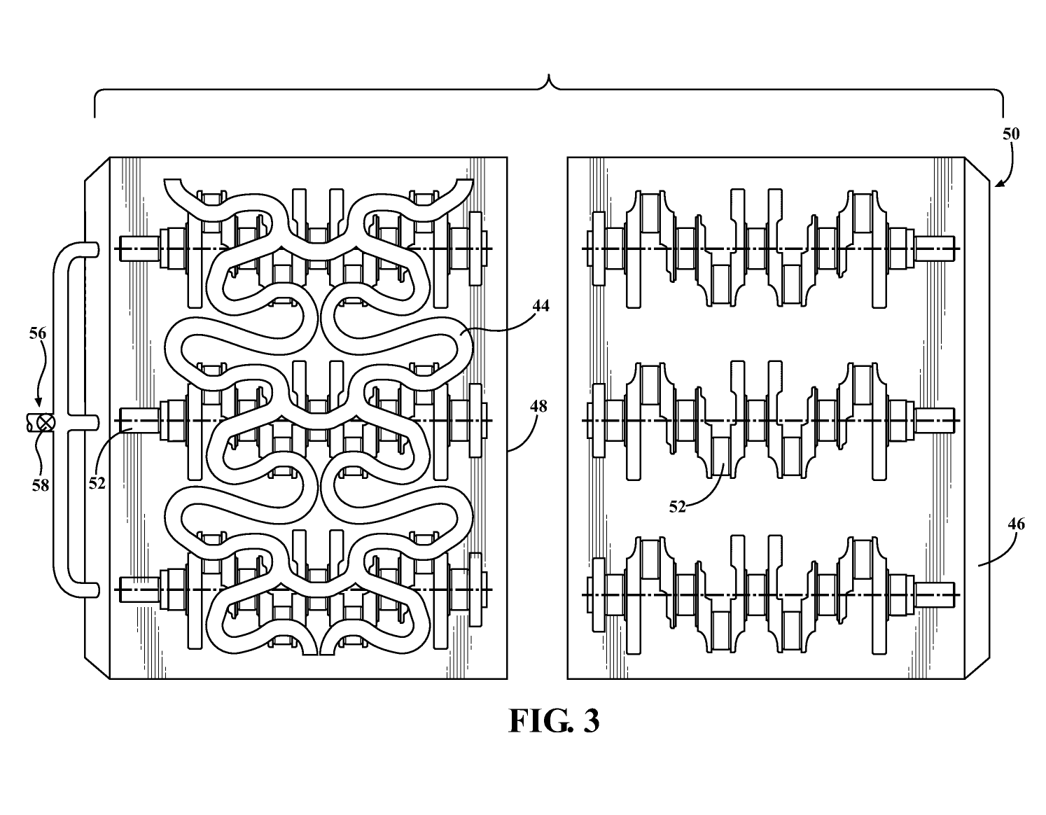

FIG. 3 depicts a plurality of crankshafts 20 arranged side by side for simultaneous forming during a casting process using a single core 44. Although three identical crankshafts 20 are shown, nothing precludes the number of crankshafts from being greater than two or the crankshafts having some dissimilar features, such as the pin bearing journals 28 or the main bearing journals 26. Preferably, the plurality of crankshafts 20 is simultaneously formed through a casting process, such as but not limited to a green sand casting process or a shell mold casting process, as generally understood by those skilled in the art. As such, referring to FIG. 3, manufacturing or casting the plurality of crankshafts 20 includes forming a first half 46 and a second half 48 of a mold 50 to define a cavity 52 therebetween simultaneously forming an exterior shape of the plurality of subject crankshafts. The first half 46 may be referred to as a cope or upper half, and the second half 48 may be referred to as a drag or lower half. As is generally understood, the first half 46 and the second half 48 of the mold 50 may be formed by pressing a template defining half of the desired finished exterior shape of the plurality of crankshafts 20 into a form of green sand or some other suitable medium, thereby leaving a negative imprint of that half of the plurality of crankshafts therein.

Upon combining the first half 46 and the second half 48 together to form the mold 50, the negative imprints therein adjoin to complete the cavity 52 and simultaneously define the exterior shape of the plurality of crankshafts 20. The exterior shape of the plurality of crankshafts 20 includes the pin bearing journals 28, the arms 27, the main bearing journals 26, and the counterweights 30 of each crankshaft. As shown in FIG. 1, each of the crankshafts 20 includes four pin bearing journals 28, eight arms 27, five main bearing journals 26, and four counterweights 30. Accordingly, the first half 46 and the second half 48 of the mold 50 are formed to collectively define a cavity 52 that forms the four pin bearing journals 28, the five main bearing journals 26, four webs with counterweights 30, and four webs without any counterweights 30 for each of the crankshafts. However, as described above, the specific number of pin bearing journals 28 and main bearing journals 26 for each of the plurality of crankshafts 20 may differ from the exemplary embodiment shown and described herein.

Each of the hollow sections 32 in each of the plurality of main bearing journals 26 and each of the pin bearing journals 28 is simultaneously formed by the single core 44 without the use of slides during casting of the plurality of crankshafts 20. Generally, slides are moving elements that are inserted into the mold to form parts and then removed so the part can be extracted from the mold. Slides typically move into a cavity positioned inside the mold perpendicular to the draw direction, to form overhanging part features. Usually, the use of slides during the casting process allows more accurate reproduction of details than traditional two-piece molds. In the present case, no slides are employed because the single core 44 is configured, i.e., designed and positioned, to define all the required features of the hollow sections 32 in the main bearing journals 26 and pin bearing journals 28 in each of the plurality of crankshafts 20. The single core 44 is formed to extend through each of the pin bearing journals 28 and the main bearing journals 26 at the precise location of the hollow sections 32 thereof, without interfering or otherwise contacting the other sections of each shaft 22, such as but not limited to the counterweights 30.

As shown in FIG. 1, the single core 44 is formed as a unitary piece configured with a shape that passes through at least one of the plurality of pin bearing journals 28 and at least one of the plurality of main bearing journals 26 in each of the plurality of crankshafts 20. As also shown, the single core 44 is configured to define a hollow section in all four of the pin bearing journals 28 and three of the main bearing journals 26 of each crankshaft 20. The single core 44 may be formed, for example, through a sand molding process as generally understood for forming cores that form voids in castings.

As shown in FIG. 2, the single core 44 may be formed to include a length of material having a circular or non-circular cross section and forming a planar shape. However, in order to use the single core 44 to simultaneously cast a plurality of crankshafts for other engine configurations, the single core 44 may be formed to include a length of material having a circular or non-circular cross section forming a non-planar three dimensional shape in each of the plurality of crankshafts 220, such as shown in FIGS. 5 through 7. Additionally, the single core 44 may be formed as a single unitary member to define or form all the hollow sections 32 in the main bearing journals 26 and the pin bearing journals 28 in each of the plurality of crankshafts 20, without otherwise touching or interfering with the other sections of each of the crankshafts 20, such as but not limited to the counterweights 30. Alternatively, the single core 44 may be formed in a manner to partially define a portion of each of the plurality of crankshafts 20, such as but not limited to the main bearing journals 26, the pin bearing journals 28, or the counterweights 30.

As shown in FIG. 2, the cross sectional shape of the single core 44 may be formed to define but is not limited to an elliptical shape. The cross sectional shape of the single core 44 may extend along a linear path or a non-linear path, and may alternatively spiral about a central axis of the cross sectional shape. The cross sectional shape of the single core 44 defines and/or forms the cross sectional shape of the hollow sections 32. As described above, the elliptical shape includes the major axis 40 having a distance between the range of 25 mm and 40 mm, and the minor axis 42 having a distance between the range of 15 mm and 35 mm. The specific cross sectional shape of the single core 44 is dependent upon the specific size, shape and configuration of each crankshaft 20, and is configured to minimize the amount of material used to form the plurality of crankshafts 20, while still providing each crankshaft 20 with all the required strength and/or stiffness. Accordingly, the cross sectional shape of the core, and the resulting hollow sections 32 defined thereby may differ from the cross sectional shape of the single core 44 shown and described herein.

The single core 44 is formed to define the path 34 that each of the hollow sections 32 extends along. Accordingly, the single core 44 may be formed to define a non-linear path 36 relative to the longitudinal axis 24. The non-linear path 36 may include a curved or non-linear path 36, or a linear angled path 38 that is angled relative to the longitudinal axis 24 as described above. The paths 34 of each of the hollow sections 32 are configured to bend or angle the hollow sections 32 away from high stress regions of each of the plurality of crankshafts 20, thereby retaining as much material around the high stress regions of the crankshafts as possible to improve the strength thereof, while minimizing the weight of the subject crankshafts. For example, a region 54 of each of the plurality of crankshafts 20 between an adjacent main bearing journal 26 and pin bearing journal 28 may be defined as a high stress region 54. As such, the path 34 that the hollow sections 32 follow through either of the adjacent main bearing journal 26 and pin bearing journal 28 of each of the plurality of crankshafts 20 directs the hollow section 32 away from the intersection between the adjacent main bearing journal 26 and pin bearing journal 28, thereby maximizing the material in this region 54 to increase the strength of each shaft 22.

Having been properly formed as a unitary single core 44 that defines all of the hollow sections 32 through the main bearing journals 26 and the pin bearing journals 28 of the plurality of crankshafts 20, the single core 44 is positioned within the cavity 52 between the first half 46 and the second half 48 of the mold 50, as shown in FIG. 3. Once properly positioned relative to the first half 46 and the second half 48 of the mold 50, the single core 44 is automatically properly positioned to form all of the hollow sections 32 through each of the main bearing journals 26 and the pin bearing journals 28 of the plurality of crankshafts 20. Once the single core 44 is positioned within the cavity 52 and the first half 46 of the mold 50 is secured relative to the second half 48 of the mold 50, a molten metal is introduced into the cavity 52 via a mechanism 56 to form the plurality of crankshafts 20. As shown in FIG. 3, the mechanism 56 may be a system of runners, regulated via a flow valve 58, and operatively connected to the mold 50 for supplying molten metal. The molten metal flows into the cavity 52 and around the single core 44 to simultaneously form each of the hollow sections 32 extending through each of the pin bearing journals 28 and each of the main bearing journals 26 of each of the plurality of crankshafts 20. After the molten metal is introduced, e.g., poured, into the cavity 52, the molten metal is allowed to cool and solidify. Once solidified, the first half 46 and the second half 48 of the mold 50 may be separated, thereby exposing the plurality of cast crankshafts 20 and the single core 44. The single core 44 may then be removed from the crankshafts 20 by breaking, chipping and/or flushing away the material forming the single core 44, thereby leaving the plurality of crankshafts 20 with the hollow sections 32 formed in each one.

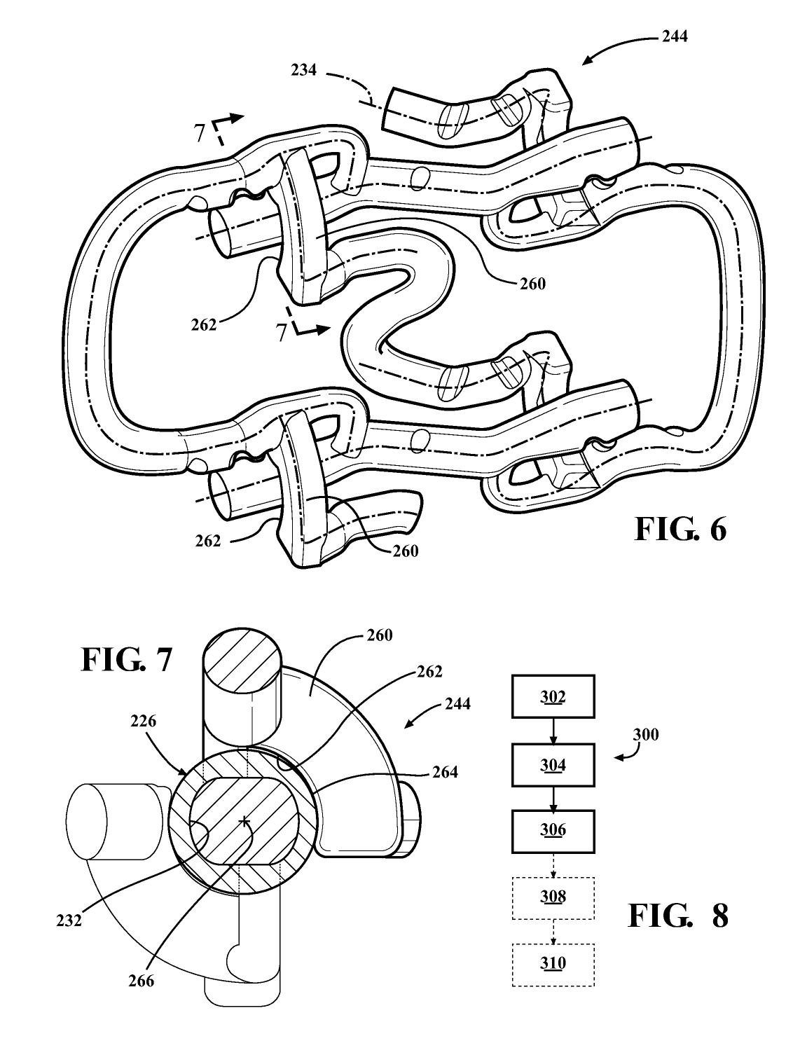

Referring to FIGS. 5 through 7, an alternative embodiment of a representative crankshaft is generally shown at 220. The crankshaft 220 is representative of the type generally designed for use in 3-cylinder, as well as certain V-6 and V-8 engines. The crankshaft 220 includes a plurality of main bearing journals 226, a plurality of pin bearing journals 228, and a plurality of counterweights 230. The pin bearing journals 228 of each crankshaft 220 are not disposed along a common plane. As such, a single non-planar core 244 is used to define a plurality of hollow sections in each of the main bearing journals 226 and the pin bearing journals 228. FIG. 6 shows the single non-planar core 244 employed to simultaneously cast a plurality of non-planar crankshafts 220. Similar to the core 44 described as being used to cast the plurality of crankshafts 20, the single non-planar core 244 is employed without the use of slides when the plurality of crankshafts 220 is cast. Accordingly, no slides are employed because the single core 244 is configured to define all the required features of the hollow sections in the main bearing journals 226 and pin bearing journals 228 in each of the plurality of crankshafts 220.

The single non-planar core 244 includes a plurality of connecting portions 260. Each connecting portion 260 includes a surface that forms at least a portion of one of the main bearing journals 226, one of the pin bearing journals 228, or one of the counterweights 230 of each of the plurality of crankshafts 220. This allows a size of the non-planar core 244 to be increased in this region, thereby improving the strength of the non-planar core 244. As best shown in FIG. 7, each connecting portion 260 may include a radially inner surface 262 that forms an exterior surface 264 of one of the main bearing journals 226. This connecting portion 260 may form part of the crankshaft exterior surface that cannot be formed by either the cope 46 or drag 48 halves of the cavities 52 formed by the templates. However, it should be appreciated that the single non-planar core 244 may be formed to include as many connecting portions 260 that form at least a portion of one of the pin bearing journals 228, one of the main bearing journals 226, or one of the counterweights 230 of each of the plurality of crankshafts 220, as required by the actual number of crankshafts being cast.

With continued reference to FIG. 7, a hollow section 232 of the main bearing journal 226 is formed to spiral about a center 266 of the hollow section 232 for each of the plurality of crankshafts 220. As such, the non-planar core 244 also includes a similar spiral shape to define the spiral path of the hollow section 232 extending through the main bearing journal 226 of each of the plurality of crankshafts 220. Such a spiral configuration of the hollow sections 232 allows the minor axis height and distance from the path 234 to be optimized to maximize weight reduction of the subject crankshafts 220. It should be appreciated that any of the hollow sections in any of the main bearing journals 226 and the pin bearing journals 228 in each of the plurality of crankshafts 220 may extend along and spiral about their respective centers.

FIG. 8 depicts a method 300 of simultaneously manufacturing a plurality of crankshafts 20 shown in FIGS. 1-4 or crankshafts 220 shown in FIGS. 5-7. Accordingly, the method commences in frame 302 with providing a single planar core 44 or a single non-planar core 244 for the casting process. In frame 302, the method includes forming the single core 44 or 244 as a unitary piece to have a shape that passes through the at least one of the plurality of pin bearing journals 28 or 228 and the at least one of the plurality of main bearing journals 26 or 226 of each of the plurality of crankshafts 20 or 220.

Following frame 302 the method advances to frame 304, where the method includes positioning a single planar core 44 or a single non-planar core 244 within the cavity 52 of the mold 50 shown in FIG. 3. Following frame 304 the method proceeds to frame 306, where the method includes introducing into the cavity 50 via the mechanism 56 a molten metal to form the plurality of crankshafts 20 or 220. In the frame 306, the molten metal flows into the cavity 50 and around the single core 44 or 244 to simultaneously form a hollow section extending through at least one of the plurality of pin bearing journals 28 or 228 and at least one of the plurality of main bearing journals 26 or 226 of each of the plurality of crankshafts 20 or 220.

Additionally, following frame 306 the method may advance to frame 308, where, once solidified, the first half 46 and the second half 48 of the mold 50 may be separated, thereby exposing the plurality of cast crankshafts 20 or 220 and the single core 44 or 244. Following frame 308, the single core 44 or 244 is then removed from the crankshafts by breaking, chipping and/or flushing away the material forming the single core 44 or 244 in frame 310, thereby leaving the plurality of crankshafts 20 or 220 with the hollow sections 32 formed in each one.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. A method of simultaneously manufacturing a plurality of crankshafts, the method comprising:
positioning a single core within a cavity of a mold having a first half and a second half together forming an exterior shape of the plurality of crankshafts, wherein the exterior shape of each of the plurality of crankshafts includes a plurality of pin bearing journals and a plurality of main bearing journals; and
introducing into the cavity via a mechanism a molten metal to form the plurality of crankshafts, wherein the molten metal flows into the cavity and around the single core to simultaneously form a hollow section extending through at least one of the plurality of pin bearing journals and at least one of the plurality of main bearing journals of each of the plurality of crankshafts.

2. The method as set forth in claim 1, further comprising forming the single core as a unitary piece to have a shape that passes through the at least one of the plurality of pin bearing journals and the at least one of the plurality of main bearing journals of each of the plurality of crankshafts.

3. The method as set forth in claim 2, wherein the single core further includes a plurality of lengths of material such that each of the lengths forms a planar shape.

4. The method as set forth in claim 2, wherein the single core further includes a plurality of lengths of material such that each of the lengths forms a non-planar three dimensional shape.

5. The method as set forth in claim 2, wherein the single core includes a plurality of lengths of material such that each of the lengths includes a cross section defining a non-circular shape.

6. The method as set forth in claim 5, wherein the non-circular shape of each of the plurality of length cross sections is an elliptical shape.

7. The method as set forth in claim 2, wherein forming the single core as a unitary piece to have a shape that passes through the at least one of the plurality of pin bearing journals and the at least one of the plurality of main bearing journals of each of the plurality of crankshafts includes forming the single core to define a plurality of non-linear paths, and wherein each non-linear path is arranged relative to a longitudinal axis of a respective one of the plurality of crankshafts for at least one of the hollow sections extending through at least one of the plurality of pin bearing journals or at least one of the plurality of main bearing journals of each of the plurality of crankshafts.

8. The method as set forth in claim 7, wherein each non-linear path includes a non-linear path positioned to bend the hollow section away from a high stress region of one of the plurality of crankshafts.

9. The method as set forth in claim 7, wherein each non-linear path includes an angled path that is angled relative to the longitudinal axis of one of the plurality of crankshafts to linearly direct the hollow section away from a high stress region of the respective crankshaft.

10. The method as set forth in claim 2, wherein forming the single core as a unitary piece includes forming the single core to include a plurality of connecting portions each having a surface that defines at least a portion of one of the main bearing journals, one of the pin bearing journals, or one of a plurality of counterweights of one of the plurality of crankshafts.

11. A system for simultaneously manufacturing a plurality of crankshafts, the system comprising:
a mold having a first half and a second half together forming an exterior shape of the plurality of crankshafts and defining an inner cavity, wherein the exterior shape of each of the plurality of crankshafts includes a plurality of pin bearing journals and a plurality of main bearing journals; a single core within the inner cavity of the mold defining a hollow section extending through at least one of the plurality of pin bearing journals and at least one of the plurality of main bearing journals of each of the plurality of crankshafts; and
a mechanism configured to introduce a molten metal into the cavity to form the plurality of crankshafts such that the molten metal flows into the cavity and around the single core to simultaneously form a hollow section extending through at least one of the plurality of pin bearing journals and at least one of the plurality of main bearing journals of each of the plurality of crankshafts.

12. The system as set forth in claim 11, wherein the single core is formed as a unitary piece to define a shape that passes through the at least one of the plurality of pin bearing journals and the at least one of the plurality of main bearing journals of each of the plurality of crankshafts.

13. The system as set forth in claim 12, wherein the single core further includes a plurality of lengths of material each forming a planar shape.

14. The system as set forth in claim 12, wherein the single core further includes a plurality of lengths of material each forming a non-planar three dimensional shape.

15. The system as set forth in claim 12, wherein the single core further includes a plurality of lengths of material each having a cross section defining a non-circular shape.

16. The system as set forth in claim 15, wherein the non-circular shape of each of the plurality of length cross sections is an elliptical shape.

17. The system as set forth in claim 12, wherein the single core defines a plurality of non-linear paths, and wherein each non-linear path is arranged relative to a longitudinal axis of a respective one of the plurality of crankshafts for at least one of the hollow sections extending through at least one of the plurality of pin bearing journals or at least one of the plurality of main bearing journals of each of the plurality of crankshafts.

18. The system as set forth in claim 17, wherein each non-linear path includes a non-linear path positioned to bend the hollow section away from a high stress region of one of the plurality of crankshafts.

19. The system as set forth in claim 17, wherein each non-linear path includes an angled path that is angled relative to the longitudinal axis of one of the plurality of crankshafts to linearly direct the hollow section away from a high stress region of the respective crankshaft.

20. The system as set forth in claim 12, wherein the single core includes a plurality of connecting portions each having a surface that defines at least a portion of one of the main bearing journals, one of the pin bearing journals, or one of a plurality of counterweights of one of the plurality of crankshafts.
